(19) United States
(12) Patent Application Publication
(10) Pub. No.: US 2004/0049545 A1
(43) Pub. Date: Mar. 11, 2004

(54) Instant message notification via caller ID

(76) Inventors: Terry Wayne Lockridge, Indianapolis, IN (US); Mike Arthur Derrenberger, Fishers, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/236,277

(22) Filed: Sep. 6, 2002

(51) Int. Cl. G06F 15/16; H04M 1/56

(52) U.S. Cl. 709/206; 709/207; 379/142.15

(57) ABSTRACT

An intended recipient of an instant message receives notification of that message via a caller identification message displayed on a device (26, 28, 32) capable of displaying caller identification messages. Upon receipt of an instant message, a broadband modem (16) generates a caller identification message that is then routed by a router (22) to the caller identification display device(s).

### TECHNICAL FIELD

This invention relates to a technique for providing notification of a message from a data network, such as the Internet, to a recipient via a Caller Identification (caller ID) message.

### BACKGROUND ART

The proliferation of the Internet, and in particular, the proliferation of Internet Service Providers (ISPs) that offer subscribers relatively low cost access, has led to the widespread exchange of electronic messages between subscribers. Many ISPs such as America On-Line (AOL) and The Microsoft Network (MSN), as well as some Internet electronic mail providers, such as Yahoo, currently offer instant messaging capability whereby an ISP subscriber can initiate an instant messaging session with one or more selected recipients. Assuming one or more of the message recipients is currently “on line”, the message sender and message recipient(s) can communicate nearly instantly with each other by typing or otherwise entering a desired message, such as by using speech-to-text for translating spoken words. Instant messaging has widespread popularity among ISP subscribers, especially among young adults who often spend significant time on line exchanging instant messages among friends.

To receive an instant message, the intended recipient must be on line. Currently, an intended recipient has no way of knowing that some one wishes to commence an instant messaging session unless the recipient is on line. Not infrequently, an intended message recipient, although off line, is nonetheless physically present at home or in the office and thus is physically proximate a computer. If the intended recipient had knowledge of the instant messaging attempt, then the recipient could then go on line and commence an instant messaging session with the message sender.

Thus, there is need for a technique that alerts an off-line Internet subscriber of an instant message.

### BRIEF SUMMARY OF THE INVENTION

Briefly, in accordance with present principles, a method is provided for alerting an intended message recipient of an instant message originated by a sender. The method commences upon receipt of the instant message along with an identification of the sender, the identification typically embedded in the message. Following receipt instant message, a caller identification message containing the identity of the sender of the instant message is generated. The caller identification message is then routed to at least one caller identification device for display. The caller identification display can take the form of a stand-alone caller identification display device or a general-purpose display device such as a television set for example, having the capability of displaying caller identification information.

### BRIEF DESCRIPTION OF THE DRAWINGS

FIG. 1 depicts a block schematic diagram of a network for practicing the instant message notification technique of the present principles; and

FIG. 2 depicts of a block schematic diagram of a router comprising part of the network of FIG. 1.

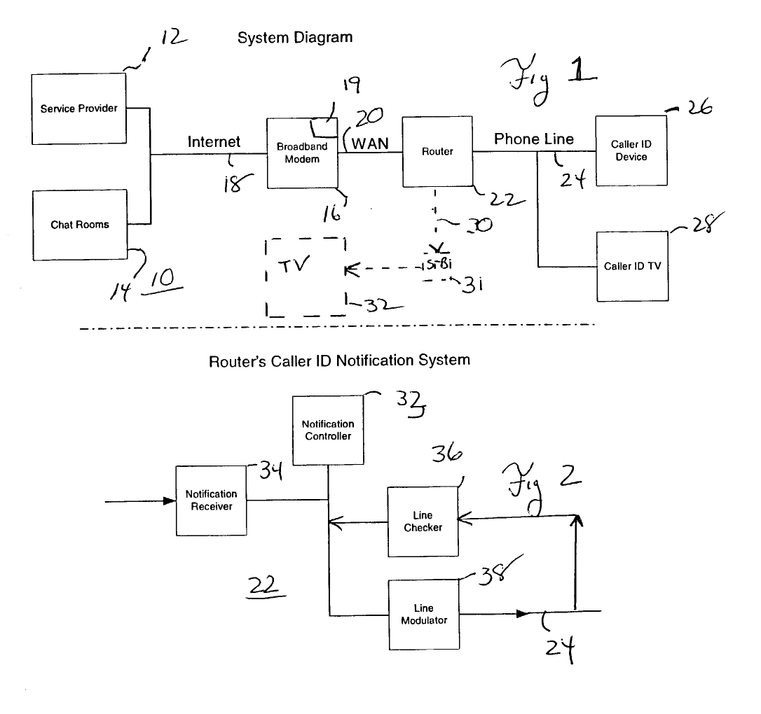

FIG. 1 depicts a block schematic diagram of a network 10 in accordance with present principles for providing a notification to an intended recipient (not shown) of an incoming instant message via a caller identification message. The term instant message refers to an incoming electronic message from an Internet Service Provider 12 or a chat room 14, which message can have a proprietary format, such in the case with instant messages originated by America On-Line, or a non-proprietary, generally recognized instant messaging format, such as the ICQ instant message format. Such instant messages include an identification of the sender and are intended for immediate delivery to a computer (not shown) for display on a monitor (not shown) or the like. The term caller identification message refers to a signal that identifies an incoming telephone caller in compliance with the Bellcore GR 30 Core requirements, available from Telcordia, Morristown, N.J., and FCC Part 68 (both standards incorporated by reference herein).

The network 10 of the present principles includes a modem 16, typically although not necessarily, a broadband modem, for receiving incoming instant messages from the Internet Service Provider 12 and/or chat room 14 over one or more TCP/IP links 18. The TCP/IP link(s) 18 comprise at least part of a private data network, a public data network, such as the Internet, or a combination of private and public networks (not shown). The modem 16 includes a message generator 19 for parsing the instant message to obtain the identity of the sender in order to generate a conventional format caller identification message (with the sender's name) for transmission across one or more links 20 to a router 22. In practice, the link(s) 20 exist within a Wide Area Network (WAN), or within a Local Area Network (LAN), or a combination of such networks.

The router 22, described in greater detail with respect to FIG. 2, modulates the caller identification signal generated by the modem 16 onto a telephone line 24 for receipt by a conventional caller identification device 26 well known in the art. One or more other devices 28, such as a television set or the like, that have caller identification display capability, can also receive and display the caller identification message. In this way, the intended message recipient, even if off line from his or her computer (not shown), can nonetheless receive notification of the receipt of an instant message, via one of the devices 26 and 28, respectively.

In addition to routing the caller identification message over the telephone line 24, the router 22 can also route the caller identification message over a broadband communication link 30, such as a cable television line, for receipt by an interface unit 31, such as a Set Top Box (STB), having caller identification capability. In turn, the STB 31 routes a caller identification display, together with video information, typically in the form of an RF signal, to a television set 32. Thus, in this way, the intended message recipient can receive via the television set 32 notification of the receipt of the instant message.

FIG. 2 depicts a block schematic diagram of a portion of the router 22 for handling the caller identification message from the broadband router 16. As shown in FIG. 2, the router 22 includes a notification controller 33, typically in the form of a programmed microprocessor, or a logic array, that controls a notification receiver 34 that receives the incoming caller identification message. Within the router 22 of FIG. 2, a line checker 36 functions to check the status of the telephone line 24, and to alert the Notification controller 33 accordingly. Specifically, the line checker 36 determines whether the line 24 is off-hook, ringing, and whether another caller identification message is present. Upon receiving a notification from the line checker 36 that the telephone line 24 is free, the Notification controller 33 causes the Notification receiver 34 to pass the incoming caller identification message to a line modulator 38. In turn, the line modulator 38 modulates the caller identification message onto the telephone line 24.

In the illustrated embodiment of FIG. 1, the broadband modem 16 and the router 22 exist as separate elements. However, a single element could perform the separate functions of the broadband modem and the router.

The foregoing describes a method and apparatus for providing notification of a message from a data network, such as the Internet, to a subscriber via a Caller Identification message.

1. A method of notifying an intended message recipient of an instant message originated by a sender, comprising the steps of:
receiving the instant message along with an identification of the message sender;
generating a caller identification message containing notification of the instant message and identification of the sender; and
routing the caller identification message to at least one caller identification device for display.

2. The method according to claim 1 wherein the routing step comprises the step of routing the caller identification message over a telephone line.

3. The method according to claim 1 wherein the routing step comprises the step of routing the caller identification message over a broadband link.

4. The method according to claim 1 wherein the receiving step comprises the step of receiving the instant message from an Internet Service Provider.

5. The method according to claim 1 wherein the receiving step comprises the step of receiving the instant message from a chat room.

6. The method according to claim 1 wherein the generating step comprises for parsing the instant message to obtain the identity of the sender.

7. Apparatus for notifying an intended message recipient of an instant message originated by a sender, comprising:
means for receiving the instant message along with an identification of the sender;
means for generating a caller identification message containing notification of the instant message and identification of the sender; and
means routing the caller identification message to at least one caller identification device for display.

8. The apparatus according to claim 7 wherein the receiving means and generating means collectively comprise a broadband modem.

9. The apparatus according to claim 8 wherein the broadband modem comprises a message generator for parsing the instant message to obtain the identity of the sender.

10. The apparatus according to claim 7 wherein the routing means comprises:
a Notification receiver for receiving the caller identification signal;
a line checker for monitoring the status of a communications link for carrying the caller identification message to the one caller identification device;
a line modulator for modulating the caller identification message onto the communication link; and
a Notification controller responsive to the status of the communications link as monitored by the line checker for causing the line modulator to receive the caller identification message from the notification receiver when the communication link is free of traffic.

11. Apparatus for notifying an intended message recipient of an instant message originated by a sender, comprising:
a broadband modem for receiving the instant message along with an identification of the sender and for generating a caller identification message containing notification of the instant message and identification of the sender; and
a router the caller identification message to at least one caller identification device for display.

12. The apparatus according to claim 11 wherein the broadband modem comprises a message generator for parsing the instant message to obtain the identity of the sender.

13. The apparatus according to claim 11 wherein the routing means comprises:
a Notification receiver for receiving the caller identification signal;
a line checker for monitoring the status of a communications link for carrying the caller identification message to the one caller identification device;
a line modulator for modulating the caller identification message onto the communication link; and
a Notification controller responsive to the status of the communications link as monitored by the line checker for causing the line modulator to receive the caller identification message from the notification receiver when the communication link is free of traffic.

14. For use in a system that provides a notification to an intended message recipient of an instant message originated by a sender via a caller identification message,
a broadband modem for receiving the instant message along with an identification of the sender and for generating a caller identification message containing notification of the instant message and identification of the sender.

15. For use in a system that provides a notification to an intended message recipient of an instant message originated by a sender via a caller identification message,
a router for the caller identification message across a communications link to at least one caller identification device for display, the router comprising:
a Notification receiver for receiving the caller identification signal;
a line checker for monitoring the status of a communications link for carrying the caller identification message to the one caller identification device;
a line modulator for modulating the caller identification message onto the communication link; and
a Notification controller responsive to the status of the communications link as monitored by the line checker for causing the line modulator to receive the caller identification message from the notification receiver when the communication link is free of traffic.
